(19) United States
(12) Patent Application Publication
(10) Pub. No.: US 2024/0375078 A1
(43) Pub. Date: Nov. 14, 2024

(54) COULOMB-FORCE DRIVEN CO2 RELEASE UPON ELECTROMAGNETIC RADIATION IN AMINE CONTAINING SOLID SORBENTS

(71) Applicant: Mosaic Materials, Inc., Alameda, CA (US)

(72) Inventors: Graham Wenz, Richmond, CA (US); James Storey, Houston, TX (US); Jared Blanton, Oakland, CA (US); Nathan Gilliland, Piedmont, CA (US); Ignacio Luz-Minguez, Alameda, CA (US)

(21) Appl. No.: 18/316,788

(22) Filed: May 12, 2023

(51) Int. Cl. B01J 20/22; B01D 53/62; B01D 53/82; B01D 53/96; B01J 20/28; B01J 20/34; C01B 32/50

(52) U.S. Cl. CPC B01J 20/226; B01D 53/62; B01D 53/82; B01D 53/96; B01J 20/28042; B01J 20/3425; B01J 20/3441; C01B 32/50; B01D 2253/204; B01D 2253/25; B01D 2253/308; B01D 2253/342; B01D 2257/504; B01D 2257/80; B01D 2259/40094

(57) ABSTRACT

A method of selectively releasing CO₂ from a CO₂ loaded solid sorbent includes: applying an electromagnetic radiation having an intensity of greater than or equal to 0.7 watt per square centimeter and a frequency of about 400 terahertz to about 70 kilohertz to the CO₂ loaded solid sorbent to release CO₂; wherein the CO₂ loaded solid sorbent comprises chemisorbed CO₂, physisorbed CO₂, or a combination thereof, and a solid sorbent; and the solid sorbent comprises at least one amine compound.

### BACKGROUND

This disclosure is directed to a method of releasing carbon dioxide from a solid sorbent, in particular a method to release carbon dioxide in an energy efficient manner.

Carbon dioxide adsorption separation technology is a cyclic process. After an adsorbent is saturated with CO₂, a desorption step, or regeneration, is required. The desorption step is fundamental for the reuse of the solid sorbent and for the recovery of CO₂ for storage. The desorption is also a crucial part of the capture chain, and is significantly responsible for the efficiency of the entire process.

Amine-functionalized solid sorbents are widely used in cyclic adsorption processes for carbon capture. Regeneration of CO₂ from these materials may be conducted through pressure, temperature, vacuum swing and/or combinations of these condition changes. In direct air capture (DAC) of CO₂ from the atmosphere, strong CO₂-sorbent interactions are necessary to selectively remove CO₂ from air, preferentially to other components. As such, the state-of-the-art processes and applications of solid sorbent materials for DAC require a thermal swing to provide a majority of the energy for release of CO₂ from the materials.

One of the largest barriers to commercially viable DAC processes is the cost for energy-intensive regeneration cycles. Traditional thermal swing approaches require heating both the solid materials used to capture CO₂ as well as the devices (cartridges, piping, etc.) within the system, leading to large thermal sinks and parasitic energy losses. Furthermore, it takes time to heat all these components, increasing cycle times and reducing system productivity.

In addition, many sorbents are thermally insulating, accordingly, heat distribution can be an issue. Accordingly, there is a continuing need for methods that are effective to release carbon dioxide from a solid sorbent in an energy efficient manner.

### SUMMARY

A method of selectively releasing CO₂ from a CO₂ loaded solid sorbent includes: applying an electromagnetic radiation having an intensity of greater than or equal to 0.7 watt per square centimeter and a frequency of about 400 terahertz to about 70 kilohertz to the CO₂ loaded solid sorbent to release CO₂; wherein the CO₂ loaded solid sorbent comprises a solid sorbent and chemisorbed CO₂, physisorbed CO₂, or a combination thereof; and the solid sorbent comprises at least one amine compound.

A method of removing carbon dioxide from a gaseous environment or an effluent gas stream includes: exposing a solid sorbent to the gaseous environment or the effluent gas stream; removing CO₂ from the gaseous environment or the effluent gas stream to form a CO₂ loaded solid sorbent; and applying an electromagnetic radiation having an intensity of greater than or equal to 0.7 watt per square centimeter and a frequency of about 400 terahertz to about 70 kilohertz to the CO₂ loaded solid sorbent to release CO₂ and regenerate the solid sorbent; wherein the CO₂ loaded solid sorbent comprises the solid sorbent and chemisorbed CO₂, physisorbed CO₂, or a combination thereof; and the solid sorbent comprises at least one amine compound.

### BRIEF DESCRIPTION OF THE DRAWINGS

A description of the figures, which are meant to be exemplary and not limiting, is provided in which:

FIG. 1 shows examples of possible compounds that may be present in a CO₂ loaded solid sorbent;

FIG. 2A and FIG. 2B are graphs of infrared (IR) intensity versus wavenumber (inverse centimeter, cm⁻¹), showing Fourier transform infrared (FTIR) characterization of a CO₂ loaded solid sorbent before and after heating at 100° C. under nitrogen in a DRIFT cell, where the IR intensity is measured by an IR reflection experiment, and the signal strength is proportional to IR absorbance;

FIG. 3A and FIG. 3B are graphs of IR absorbance (Optical Density, OD) versus wavenumber (cm⁻¹), showing FTIR characterization of a CO₂ loaded solid sorbent before and after heating gradually from 28° C. to 150° C. in a temperature cell;

FIG. 3C is a graph of IR absorbance change versus sorbent temperature (C) and shows the temperature dependence of the IR signal change when the solid sorbent is transitioned from a state with bound CO₂ to a state with CO₂ released;

FIG. 3D is a graph illustrating the CO₂ release versus the sorbent temperature (° C.), where the CO₂ IR signals from 2100 to 2600 cm⁻¹ in the gas phase were integrated and plotted as a function of the sorbent temperature;

FIG. 4A is a graph of IR absorbance versus wavenumber (cm⁻¹) of a CO₂ loaded solid sorbent before (black line) and after (grey line) continuous wave (cw) IR illumination with 7 milliwatts (mW) power for 50 hours, where the wavenumber range of the illuminating light was 2670 to 2350 cm⁻¹ (full width at half maximum, FWHM) set by IR bandpass filters, the total energy of the investigated sample was 0.14 Joule, and the light intensity at the sample was 0.005 watt per square centimeter (W/cm²); the intensity in the frequency range ≥300 GHz is defined as the illumination power over the illumination spot size;

FIG. 4B shows the CO₂ IR absorbance increase in the wavenumber range of 2400-2300 cm⁻¹, where the CO₂ IR absorbance was measured for the CO₂ released from the investigated sample;

FIG. 5A is a graph of IR absorbance versus wavenumber (cm⁻¹) of a CO₂ loaded solid sorbent before (black line) and after (grey line) illumination with an excitation wavenumber of 2650-2400 cm⁻¹ (FWHM) and a power of 2 mW for 5 minutes by a short IR pulse of about 300 femtoseconds (fs) with a repetition rate of 1 kilohertz (KHz), where a total energy of the illumination was 0.0007 Joule, and an intensity at the sample was 51 megawatt per square centimeter (MW/cm²);

FIG. 5B shows the released CO₂ IR absorbance difference in the wavenumber range of 2300-2400 cm⁻¹ upon illumination as described for FIG. 5A;

FIG. 5C is a graph of IR absorbance versus wavenumber (cm⁻¹) of a CO₂ loaded solid sorbent before (black line) and after (gray line) an illumination at 800 nm (12500 cm⁻¹) with 1.97 W power for 2 minutes by a short near infrared (NIR) pulse of about 80 fs with a repetition rate of 1 kHz, where the total energy was 0.24 Joule, and the intensity at the sample was 31 gigawatts per square centimeter (GW/cm²);

FIG. 6 shows the evolution of CO₂ from a CO₂ loaded solid sorbent when excited with 2.45 gigahertz (GHz) microwave energy under nitrogen gas, where the solid line is a graph of the volume ratio of the released CO₂ relative to the volume of the nitrogen gas versus illumination time (second, sec), and the dashed line is a graph of the CO₂ mass spectrum versus the illumination time (sec);

FIG. 7A shows a CO₂ release profile under conductive, thermal heating with nitrogen flow, where the solid line is a graph of the amount of CO₂ released (parts per million, ppm) versus the heating time (minute, min), and the dashed line is a graph of the heating temperature (C) versus the heating time (min);

FIG. 7B shows a CO₂ release profile when 2.45 GHz microwave energy is applied to a CO₂ loaded solid sorbent, and is a graph of the amount of CO₂ released (ppm) versus illumination time (minute, min); and

FIG. 8 shows CO₂ release profiles under two different microwave power (700 and 1000 watts (W)), illustrating drastic difference on CO₂ release with small differences in temperature (dots), where the solid line and dashed line are graphs of regeneration flow rate (milli liter per minute, mL/min) versus illumination time (min) under 700 W and 1,000 W microwave power respectively, and the solid dots and empty dots show the local temperature measured in the solid sorbent (° C.) as a function of the illumination time (min) under 700 W and 1,000 W microwave illumination power respectively, wherein the intensity of the microwave illumination in the frequency range of <300 GHz is defined as the illumination power over the wavelength squared, and since the wavelength was 12.24 cm (the size of the sample bed), the used intensity was 4.67 W/cm² (for 700 W power) and 6.67 W/cm² (for 1000 W power).

### DETAILED DESCRIPTION

A detailed description of one or more embodiments is presented herein by way of exemplification and not limitation.

In the past, the carbon dioxide release from solid sorbents has relied on conventional mechanisms of heating: convective and conductive. The method disclosed herein is non-thermal, and CO₂ release is a result of the incident light and/or electromagnetic field. In particular, the inventors hereof have found that single photon absorption of the electromagnetic field can directly lead to CO₂ release. The absorbed photon induces an increase of vibrational amplitude of bonds in the solid sorbent that lead to CO₂ release. As used herein, single photon absorption is defined as a linear dependence of the impact of the sorbent with the number of illuminated photons or intensity. In addition, the electric field can act on the charged groups in the CO₂ loaded solid sorbent and release CO₂. The action of the electric field on the charged groups to release CO₂ is independent of the frequency of light. As it is a direct electric field effect. CO₂ release is non-thermal.

Compared to thermal swings, the non-thermal method as described herein reduces the energy load for creating the thermal swing of the solid sorbent for CO₂ capture. For example, the method can increase the amount and/or rate of CO₂ release at the same energy consumption. The CO₂ release can also be at least 1%, 2%, 5%, 10%, or 30% more efficient compared to conventional heating. This provides a path for energy savings in the overall process.

Using the non-thermal method as described herein also requires less process equipment such as piping, ducts, etc. since less equipment is needed to guide electromagnetic radiation compared to heat transfer fluids like water (conduction) or CO₂ (convection).

A method of selectively releasing CO₂ from a CO₂ loaded solid sorbent comprises applying an electromagnetic radiation to the CO₂ loaded solid sorbent to release chemisorbed carbon dioxide, physisorbed carbon dioxide, or a combination thereof.

The electromagnetic radiation has a frequency of about 70 KHz to about 400 terahertz (THz), for example about 0.005 gigahertz (GHz) to about 400 THz, about 300 GHz to about 105 THz, or about 0.3 GHz to 300 GHz, or about 0.01 GHz to about 2.54 GHz, or about 0.07 MHz to about 120 THz, or about 0.07 MHz to about 1 THz, or about 0.07 MHz to about 95 THz or about 0.1 GHz to about 120 THz, or about 0.01 GHz to about 100 GHz, or about 12 THz (400 cm⁻¹) to 120 THz (4000 cm⁻¹), or about 1 THz to 12 THz, or about 0.2 THz (6.67 cm⁻¹) to 5 THz (166 cm⁻¹) or about 17 THz to about 102 THz (3400 cm⁻¹), or about 62.8 THz to about 105 THz, or 29.9 THz (997 cm⁻¹) to about 54 THz (1800 cm⁻¹).

The electromagnetic radiation can have a wavenumber of about 400 cm⁻¹ to about 4000 cm⁻¹, about 1800 cm⁻¹ to about 3000 cm⁻¹, about 1800 cm⁻¹ to about 2800 cm⁻¹, about 2200 cm⁻¹ to about 2800 cm⁻¹, or about 2350 cm⁻¹ to about 2670 cm⁻¹.

Electromagnetic radiation with an intensity of greater than or equal to 0.005 W/cm² can be used to release CO₂ from a solid sorbent. For an efficient and fast process the intensity of the electromagnetic radiation should be higher. The electromagnetic radiation has an intensity of greater than or equal to about 0.7 W/cm², specifically about 0.7 W/cm² to about 500 GW/cm². The electromagnetic radiation can have an intensity of about 0.7 W/cm² to about 1500 W/cm² for a continuous radiation or an intensity of about 5 W/cm² to about 500 GW/cm² for a pulsed radiation.

For continuous illumination, the intensity is greater than or equal to (≥) about 0.7 W/cm² or ≥about 1.4 W/cm² in the frequency range of from about 400 THz to about 12 THz. The upper limit is about 150 kW/cm². For continuous illumination in the frequency range of from about 12 THz to about 300 GHz, the intensity is ≥about 0.7 W/cm², or ≥about 1 W/cm², or ≥about 1.5 W/cm², or ≥about 15 W/cm², or ≥about 150 W/cm², or ≥about 1500 W/cm². The upper limit is about 150 kW/cm². For continuous illumination in the frequency range of from about 300 GHz to about 0.07 MHz, the intensity is ≥about 0.7 W/cm², or ≥about 1 W/cm², or ≥about 2 W/cm², or ≥about 4 W/cm², or ≥about 6 W/cm². The upper limit is about 150 kW/cm².

For pulsed illumination, the intensity is ≥about 0.005 kW/cm², or ≥about 0.5 kW/cm², or ≥about 50 kW/cm², or ≥about 5 MW/cm², or ≥about 50 MW/cm² in the frequency range of from about 400 THz to about 12 THz. For pulsed illumination in the frequency range of from about 12 THz to about 300 GHz, the intensity is ≥about 0.005 kW/cm², or ≥about 0.5 kW/cm², or ≥about 50 kW/cm², or ≥about 5 MW/cm², or ≥about 50 MW/cm². For pulsed illumination in the frequency range of from about 300 GHz to about 0.07 MHz, the intensity is ≥about 1 W/cm², or ≥about 2 W/cm², or ≥about 4 W/cm², or ≥about 6 W/cm², or ≥about 8 W/cm², or ≥about 10 W/cm². The upper intensity limit for pulsed illumination is about 500 GW/cm².

The inventors have found that at the same energy and/or the temperature level, increasing the intensity of the electromagnetic radiation increases CO₂ release in terms of the amount of the CO₂ released, the rate of the CO₂ release, or a combination thereof. This points to a new process, the Coulomb-force driven CO₂ release.

Advantageously, the electromagnetic radiation can have a single photon energy that is lower than a binding energy of the carbon dioxide with the solid sorbent. For example, the electromagnetic radiation can have a single photon energy that is at least about 100 cm⁻¹ lower, at least about 200 cm⁻¹ lower, or at least about 300 cm⁻¹, or at least about 600 cm⁻¹ lower than a binding energy of carbon dioxide with the solid sorbent.

The electromagnetic radiation can be a continuous radiation, a pulsed radiation, a non-coherent radiation, or a coherent radiation. The pulse length for the non-coherent or coherent pulsed radiation can be about 3 fs to about 1 second(s), or about 10 fs to about 1 s or about 50 fs to about 500 millisecond (ms), or about 100 fs to about 500 microsecond (μs), or about 0.5 picosecond (ps) to about 500 nanosecond (ns), or about 1 ps to about 10 ns, or about 3 fs to about 500 ns, or about 10 ps to about 1 s, or about 50 ps to about 500 ps, or about 1 ns to about 1 μs, or about 1 ms to about 1 s.

The electromagnetic radiation pulses can be produced by a non-coherent light source. Such non-coherent light sources are, for instance, standard infrared light lamps, Globars, gas discharge lamps, pulsed lasers, magnetrons, synchrotron radiation light sources such as Shanghai Synchrotron Radiation Facility (SSRF) generators, or the like. Coherent light sources can include continuously emitting lasers or continuous-wave laser. In the case of continuously emitting lasers (also referred to as continuous-wave laser) the electromagnetic light pulses can be produced by a subsequently arranged shutter or a comparable element. Every pulse duration that is longer than 1 s is defined as continuous radiation.

The illumination time can vary from a few femtoseconds to seconds to a few hours, depending on the specific solid sorbent used. The illumination can be carried out at room temperature or in temperature ranges from about 213 K to about 423 K.

The solid sorbent comprises an amine compound (also referred to as “amine”) and can additionally comprise metal sites, and optionally organic linkers. The amine, metal sites, and organic linkers can be the same as those described herein in the context of the amine-functionalized metal organic framework (MOF).

The solid sorbent can have a pore size of about 0.4 nanometer (nm) to about 10 μm, preferably about 0.5 nm to about 2 μm, or of about 0.5 nm to 0.1 μm, or of about 0.4 nm to about 50 nm, and a porosity of about 1% to about 95%, preferably about 15% to about 45% or about 25% to about 40%, more preferably about 30% to about 35%, or at least about 20%, at least about 25%, at least about 30%, at least about 35%, at least about 40%, or at least about 45%. As used herein, a pore size refers to the largest dimension of a pore. In an aspect, the pore size of the pores in the solid sorbent can be in a range of about 5 to about 20 Å, and the pore walls area can be approximately a single-molecule thick. The internal specific surface areas of the solid sorbent can be up to >˜10,000 square meters per gram (m²/g), for example about 1 m²/g to about 10,000 m²/g, preferably about 100 m²/g to 10,000 m²/g, more preferably about 1,000 m²/g to about 10,000 m²/g.

The solid sorbent is not thermally conductive, and can have a thermal conductivity of less than about 0.1 Watt per meter-Kelvin (W/mK), or less than about 0.05 W/mK, or less than about 0.01 W/mK, or less than about 0.005 W/mK.

In an aspect, the solid sorbent is an amine-functionalized MOF. MOFs include inorganic nodes connected by organic linkers. The inorganic nodes comprise metal sites, which can be ions of least one of Mg, Ca, Ba, Al, Sc, Zr, V, Cr, Mn, Fe, Co, Ni, Cu, Zn, Ti, Cd, or Eu, preferably the ions of at least one of Mg, Mn, Zn, or Ni. The organic linkers can comprise at least one of a carboxylate, a triazolate, or an imidazolate, preferably a carboxylate. Examples of the organic linkers include, but are not limited to, 4,4′-dihydroxy-(1,1′-biphenyl)-3,3′-dicarboxylate, 2,5-dihydroxybenzene-1,4-dicarboxylate, 4,6-dihydroxybenzene-1,3-dicarboxylate, benzene-1,4-dicarboxylate, benzene-1,3,5-tricarboxylate, 3,3′,4,4′-benzophenone-tetracarboxylate, benzene-1,2,4,5-tetracarboxylate, trans-1,4-cyclohexanedicarboxylate, 1H,7H-[1,4]dioxino[2,3-F:5,6-F′]bisbenzotriazolate, 1,5-dihydrobenzo[1,2-d:4,5-d′]bis([1,2,3]triazolate, 3,5-dimethyl-1H-pyrazole-4-carboxylate, 5-(pyridin-3-yl)benzene-1,3-dicarboxylate, 1,3,5-tri (1H-tetrazol-5-yl) benzene, 2-methylimidazolate, 2-ethylimidazolate, and 1-benzyl-1H-imidazolate. Other suitable known organic linkers can also be used. Preferably the organic linkers comprise 4,4′-dihydroxy-(1,1′-biphenyl)-3,3′-dicarboxylate.

Examples of the MOFs include, but are not limited to, MOF-74, MOF-274, HKUST-1, MII-100, MIL-101, MOF-525, MOF-2, MOF-505, and UiO-66. Additional MOFs include but are not limited to those described in Chem. Soc. Rev. 2020, 49, 2751-2798. A preferred MOF is Mg₂(dobpdc) where the inorganic nodes comprise Mg ions and the organic linkers comprise 4,4′-dihydroxy-(1,1′-biphenyl)-3,3′-dicarboxylate (dobpdc).

The amine can be a monoamine; a diamine such as a primary/primary diamine, a primary/secondary diamine, a primary/tertiary diamine, and a secondary/secondary diamine; a polyamine such as a triamine, a tetramine, and an aminopolymer; or a bifunctional amine.

The monoamines can be monoalkylamines, dialkylamines, trialkylamines, monoarylamines, diarylamines, triarylamines, and mixed alkyl-aryl-amines. Examples of the monoamines include, but are not limited to, aniline, n-butylamine, n-pentylamine, n-hexylamine, diphenylamine, and triethylamine.

Examples of the diamines include, but are not limited to, ethylene diamine, 2,2-dimethyl-1,3-propanediamine, 1,3-diaminopentane, 2-methylpropane-1,2-diamine, N-ethylethylenediamine, N-isopropylethylenediamine, N-butylethylenediamine, N-pentylethylenediamine, N-hexylethylenediamine, N,N-dimethylethane-1,2-diamine, N,N-diethylethylenediamine, N,N-diisopropylethylene diamine, N,N-dimethylpropylenediamine, N,N′-dimethylethane-1,2-diamine, 2-(aminomethyl) piperidine, and N,N-diethyl-N-methylethylenediamine.

Suitable polyamines include, but are not limited to, bis(3-aminopropyl)amine, N,N′-bis(3-aminopropyl)-1,4-butanediamine, tetraethylene pentamine, polyethyleneimine, and polypropyleneimine. Preferably, the functionalizing agent includes a primary/secondary diamine disclosed herein.

As used herein, a bifunctional amine refers to an amine having an additional functional group other than an amino group. Examples of the bifunctional amines include, but are not limited to, amino-alcohols (also known as alkanolamines).

The solid sorbent can be in the form of pellets. The pellets can have a particle size of about 0.1 millimeter (mm) to about 10 mm, preferably about 0.3 mm to about 3 mm, more preferably about 0.7 mm to about 1.5 mm. The solid sorbent can also be present in the form of a standalone film or a coating on another substrate or a self-standing monoliths. The film or coating can have a thickness of about 0.01 mm to about 10 mm, preferably about 0.1 mm to about 1.0 mm.

The solid sorbent can be converted to a CO₂ loaded solid sorbent upon exposure to carbon dioxide. In a CO₂ loaded solid sorbent, carbon dioxide is chemisorbed and/or physisorbed on the solid sorbent. The CO₂ loaded solid sorbent can also contain co-adsorbed water.

The CO₂ loaded solid sorbent is stable at room temperature. In an embodiment, less than about 30%, less than about 10%, less than about 3%, less than about 2%, or less than about 1% of carbon dioxide in the CO₂ loaded solid sorbent is released when the CO₂ loaded solid sorbent is stored at 20° C. and atmospheric pressure for one week without exposing the CO₂ loaded solid sorbent to the electromagnetic radiation as disclosed herein, where the percent of the released CO₂ is a volume percent based on a total volume of the CO₂ loaded to the solid sorbent.

The CO₂ loaded solid sorbent comprises charged or partially charged groups. For Coulomb-force to act on the loaded solid sorbent to drive out carbon dioxide, the CO₂ loaded solid sorbent can have a partial charge of about 0.1 to less than about 1, preferably about 0.2 to less than about 1, or about 0.5 to about 1. The partial charge is the net charge at an atom within its van der Waals radius.

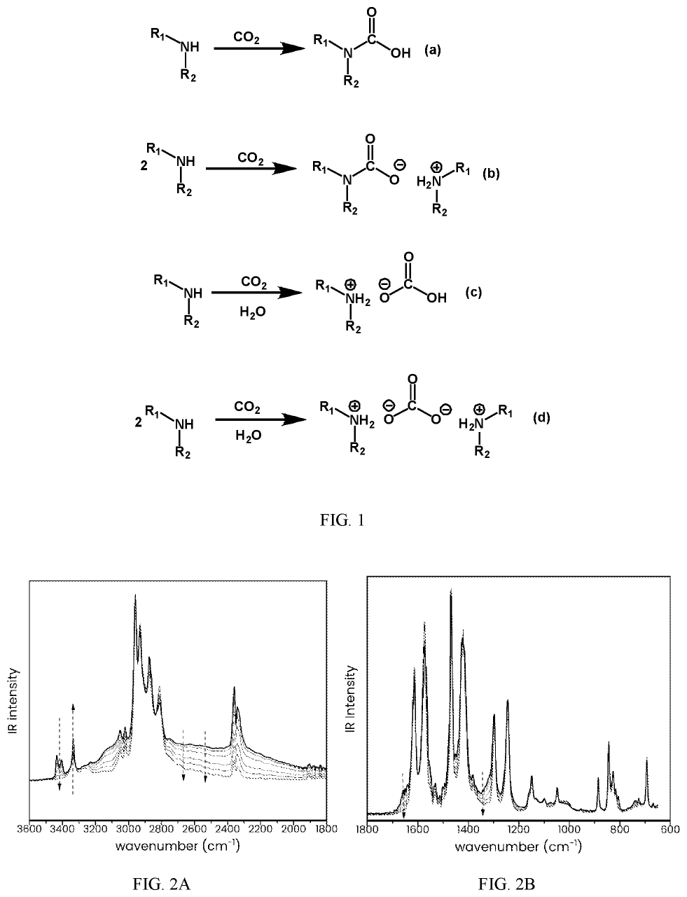

In the CO₂ loaded solid sorbent, CO₂ can react with amine and optionally water to form at least one of carbonate ions, bicarbonate ions, ammonium ions, a carbamate, or a carbamic acid. FIG. 1 illustrates the formation of a carbamic acid (a), an ammonium carbamate (b), an ammonium bicarbonate (c), and an ammonium carbonate (d), wherein R₁ and R₂ are independently H or an organic group optionally having at least one heteroatom such as N or O, provided that R₁ and R₂ are not both H. The CO₂ loaded solid sorbent can include at least one of (a), (b), (c), or (d).

In the CO₂ loaded solid sorbent, ammonium carbamate can have characteristic IR bands or marker IR bands at about 3400 cm⁻¹, about 2800-1800 cm⁻¹, about 1650 cm⁻¹, and about 1350 cm⁻¹. The broad absorption band from about 1800-2800 cm⁻¹ can be described as a broad band around 2500 cm⁻¹.

Upon application of electromagnetic radiation with a wavelength of about 1800 cm⁻¹ to about 3200 cm⁻¹, or about 1800 cm⁻¹ to about 2800 cm⁻¹, absorption takes place and some of the photons are absorbed by the vibrational band reflecting CO₂ adsorption. These vibrational bands reflecting CO₂ adsorption can be referred to as carbamate groups. The absorption of a photon results in an activation of the absorbing carbamate vibration. An activation can lead to an increased vibration amplitude. The carbamate groups are partially charged. The increased amplitude induces a periodic change of the electric field and a Coulomb force driving the CO₂ release. Otherwise the absorbed energy is redistributed via vibrational energy relaxation channels. In an aspect, the carbon dioxide is selectively released by an energy generated by a vibration excitation via a single photon process.

The activated vibration can relax via lower-frequency vibrations on a picosecond timescale until a thermal equilibration is reached. The temperature can slightly increase on a nanosecond timescale. The final temperature increase can be minimal, since the photon energy has to be redistributed over all degrees of freedom of the light absorbing substance (3N-6 vibrations, with N is the number of atoms). In an aspect, a temperature difference of the solid sorbent before and after the selective release of CO₂ is less than about 3° C., or less than about 5° C., or less than about 10° C., or less than about 30° C., or less than about 40° C.

The selective release of CO₂ can be used in DAC or other applications. A method of removing carbon dioxide from a gaseous environment or an effluent gas stream comprises exposing a solid sorbent as described herein to the gaseous environment or the effluent gas stream; removing at least a portion of the carbon dioxide from the gaseous environment or the effluent gas stream and forming a CO₂ loaded solid sorbent; and applying a continuous electromagnetic radiation having an intensity of greater than or equal to 0.7 W/cm² or a pulsed electromagnetic radiation having an intensity of greater than or equal to 1 W/cm² and a frequency of about 400 THz to about 70 kHz to the CO₂ loaded solid sorbent to release CO₂ and regenerate the solid sorbent. If desired, vacuum, inert purge gas, or a combination thereof can be applied when the solid sorbent is regenerated.

The method is further illustrated by Figures. Referring to FIG. 2A and FIG. 2B, an amine-functionalized MOF was exposed to dry 2,000 ppm CO₂ to form a CO₂ loaded solid sorbent. The IR spectrum of the CO₂ loaded solid sorbent is presented in FIG. 2A and FIG. 2B (black lines). The spectrum show characteristic IR bands at 3400 cm⁻¹, 2800-1800 cm⁻¹, 1650 cm⁻¹, and 1350 cm⁻¹, which indicate that CO₂ adsorbed on the amine-functionalized solid sorbent in the form of ammonium carbamate.

The IR spectrum does not change at room temperature, indicating that the CO₂ loaded solid sorbent is stable at room temperature, and carbon dioxide is not released without any energy applied to the loaded solid sorbent. Indeed, CO₂ can be permanently bound to a solid sorbent unless a form of energy is introduced to overcome the binding energy that binds CO₂ to the solid sorbent. The binding energy for CO₂ loaded to an amine-functionalized solid sorbent was determined to be about 70 KJ/mol or 5850 cm⁻¹. (Ref. R. L. Siegelmann et al. J. Am. Chem. Soc. 2019, 141, 13171-13186)

When the CO₂ loaded solid sorbent is heated up to 100° C., a change of the IR spectrum is observed as shown in FIGS. 2A and 2B. All characteristic IR bands attributed to the ammonium carbamate pair disappear or change as indicated by arrows as temperature increases indicating the full cleavage of the carbamate species bonded to the amine-functionalized solid sorbent.

After cooling the solid sorbent to room temperature, the initial spectrum (dark black line) can be restored by exposing the solid sorbent to CO₂ gas. The results indicate that the adsorption of CO₂ is reversible.

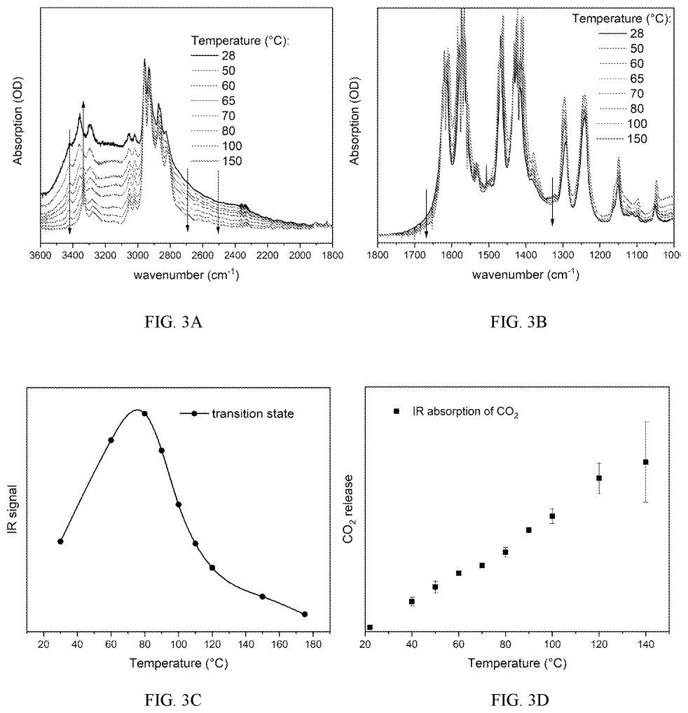

Release of CO₂ by thermal energy or temperature increase is further illustrated in FIGS. 3A-3D by change of IR marker bands and CO₂ bands. FIG. 3A and FIG. 3B show FTIR characterization of a CO₂ loaded solid sorbent (amine-functionalized MOF) before and after heating gradually from 28° C. to 150° C. in a temperature cell. Again, all characteristic IR bands attributed to the ammonium carbamate pair in the CO₂ loaded solid sorbent (i.e., 3400 cm⁻¹, 2800-1800 cm⁻¹, 1650 cm⁻¹, and 1350 cm⁻¹) disappear or change as temperature increases indicating the full cleavage of the carbamate species bonded to the amine-functionalized solid sorbent.

FIG. 3C shows the temperature dependence of the IR signal change when the solid sorbent is transitioned from a state with bound CO₂ to a state with CO₂ released. There is only one transition for heating induced CO₂ release with a peak around 70-80° C. under no gas exchange conditions. FIG. 3D shows the CO₂ release as a function of the solid sorbent temperature, and the free CO₂ gas concentration increases in the sample cell linearly and levels of after 100° C.

Instead of heating, electromagnetic radiation also induces CO₂ release as demonstrated by change of IR marker bands and CO₂ bands. The method is non-thermal and energy efficient.

To demonstrate the release of CO₂ upon IR illumination as described herein, an IR Globar lamp in combination with an IR bandpass filter (2670-2350 cm⁻¹ (FWHM)) was used to illuminate a CO₂ loaded solid sorbent (amine-functionalized MOF) for 50 hours. The CO₂ loaded solid sorbent was placed air tight between two CaF₂ windows and a Teflon spacer in a temperature cell, i.e. a sample cell combined with a thermostat to set the temperature of the cell. The solid sorbent filled about half of the temperature cell. At locations of the solid sorbent, the absorption was measured on a 0.12×0.12 millimeter (mm) spot. At locations without the solid sorbent, the gas inside the cell was measured on a 0.12×0.12 mm spot. The power of the light was 7 mW.

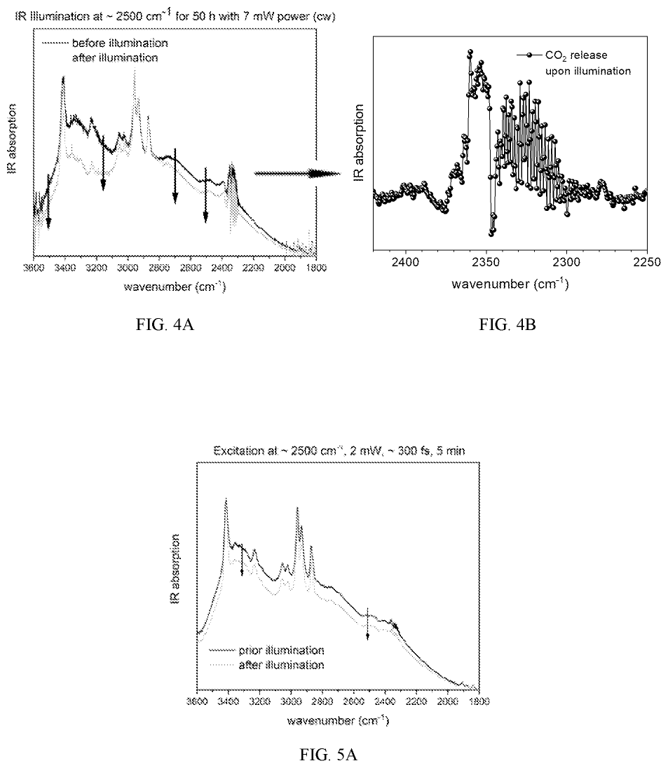

The IR absorption spectrum before and after illumination by an FTIR microscope on a CO₂ loaded solid sorbent (amine-functionalized MOF) is shown in FIG. 4A. The investigated solid sorbent area was illuminated with a total light energy of 0.14 Joule during the 50 hours illumination. The light intensity was 0.005 W/cm². Upon illumination, the concentration of CO₂ gas increased in the temperature cell as shown in FIG. 4B.

The temperature of the solid sorbent was traced with a temperature sensor. The temperature stayed constant at 23° C. during the 50 hours illumination. Accordingly, CO₂ release from a solid sorbent due to IR illumination instead of temperature increase is demonstrated.

The number of photons absorbed by the solid sorbent was smaller than 1018 because the investigated sample area was illuminated by about 1018 photons, and only about 50% of the photons interacted with the sample and could be absorbed. This gives roughly one photon for 1000 absorbing groups, which indicates CO₂ release by a single-photon absorption process. The results also indicate that the activation of a vibrational mode in the electronic ground state of the CO₂ loaded solid sorbent, here a carbamate, leads to CO₂ release.

This is very unusual, since the photon energy is used to release CO₂ instead of being distributed over the manifold of vibrational modes of the solid sorbent. Moreover, the expected binding energy (˜5850 cm⁻¹) is about two times higher than the absorbed single photon energy.

CO₂ release from a solid sorbent by electromagnetic radiation via a single photon process was not observed before. In particular, the CO₂ release takes place upon interaction with a photon having an energy that is more than 300 cm⁻¹ lower, or more than 600 cm⁻¹ lower than the CO₂ binding energy at room temperature is surprising and unexpected. Inducing a ground-state reaction, i.e. CO₂ release from a loaded solid sorbent, with an interacting photon of energy more than 300 cm⁻¹ lower than the binding energy cannot be explained by using the photon energy to overcome the binding energy. At lower temperature than room temperature, i.e. down to 213 Kevin (K), and at elevated temperatures up to 423 K, CO₂ release upon interaction with a photon having an energy that is more than 300 cm⁻¹ or 600 cm⁻¹ lower than the CO₂ binding energy at the given temperature is surprising and unexpected. Suitable temperature ranges can be from about 213 K to about 373 K, or from about 213 K to about 333 K, or from about 233 K to about 313 K, or from about 253 K to about 353 K, or from about 213 K to about 303 K.

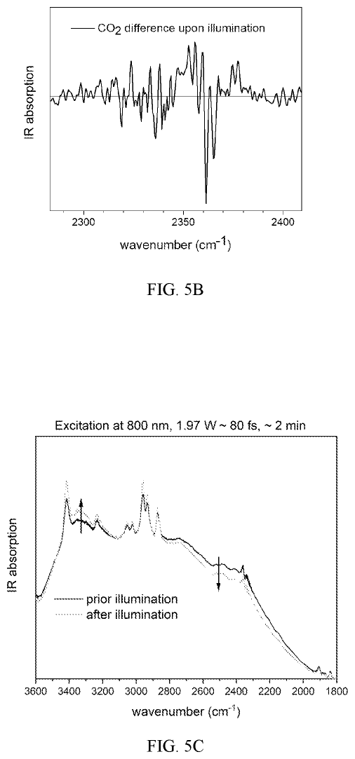

In addition to the photon energy, the intensity of the electromagnetic radiation also facilitates CO₂ release from the solid sorbent. To demonstrate this effect, a CO₂ loaded solid sorbent was illuminated with a short laser pulse of about 300 fs with a repetition rate of 1 kHz at wavenumbers from 2650 cm⁻¹ to 2400 cm⁻¹ (FWHM) with 2 mW power for 5 minutes. An intensity of about 50 MW/cm² and a total energy of 0.0007 Joule was illuminated at the investigated solid sorbent location. FIG. 5A shows a reduction in the carbamate marker band at 2500 cm⁻¹ of 15% similar to the continuous wave illumination in FIG. 4A. Here, the illumination duration for FIG. 5A was only 5 minutes compared to 50 hours in FIG. 4A. This demonstrates a significant increase in CO₂ release upon increasing the intensity at comparative total energy levels. The temperature change during the process was negligible.

In FIG. 5B, illumination with femtosecond laser pulses allows intensities of >50 MW/cm². At 12500 cm⁻¹ (or 800 nm) a total energy at the observed substance area of 0.24 Joule was used. A change in the broad absorption band around 2500 cm⁻¹ by about 8% was observed. At 800 nm the time period of the light pulses is a few femtoseconds. This means the direction of the electric field of the electromagnetic radiation is inverted on this timescale. Since the solid sorbent has no absorption at 800 nm, the observed changes are due to interaction with the strong electric field. Since the direction changes on a very fast timescale, no or negligible CO₂ release is observed, but a change of the properties of the vibrational bands is visible. In other words, the strong electric field alters the geometry of the solid sorbent. However, the fast oscillation period impedes the release of CO₂, because altering the direction of the interaction between the charged groups in the CO₂ loaded solid sorbent and the electric field is too fast.

Using lower frequencies results in slower electric field oscillations. This leads to slower change of electric field directions interacting with the substance. Lower frequencies at 2.45 GHz can be used to achieve a slower electric field oscillation. In this frequency range the electric field changes on the timescale of hundred picoseconds to nanoseconds. In this time window a released CO₂ molecule can leave the insertion place and is not affected by a reversed electric field direction anymore.

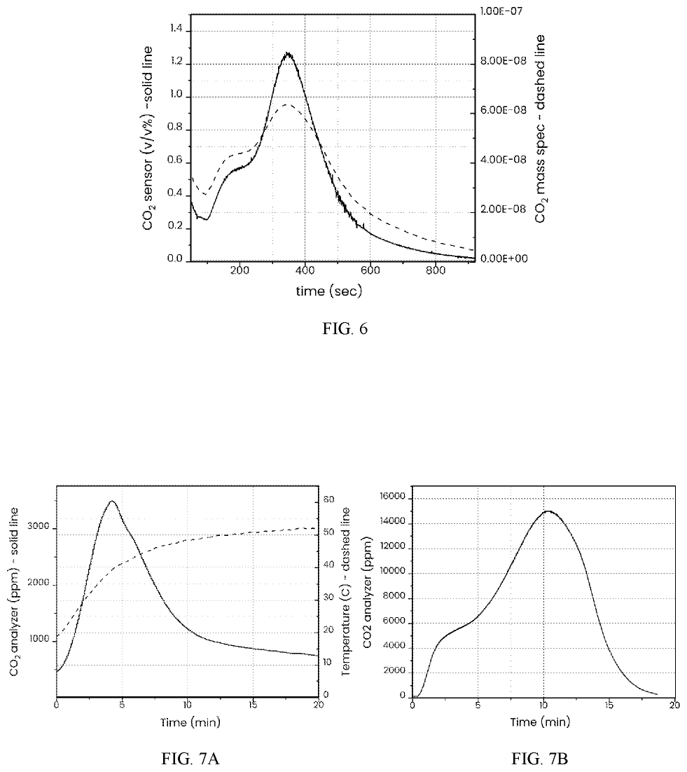

The CO₂ release upon microwave electromagnetic radiation on a CO₂ loaded solid sorbent (amine-functionalized MOF) is illustrated in FIG. 6. There are two peaks at around 180 seconds and around 350 seconds at constant microwave power and frequency. FIG. 7B shows similar CO₂ release profile when 2.45 GHz microwave energy was applied to a CO₂ loaded solid sorbent (amine-functionalized MOF). This points to two CO₂ release channels.

In contrast, as shown in FIG. 7A, the CO₂ release is monitored upon temperature increase, there is one peak around 4 minutes when the CO₂ release is induced by heating/temperature increase without electromagnetic radiation.

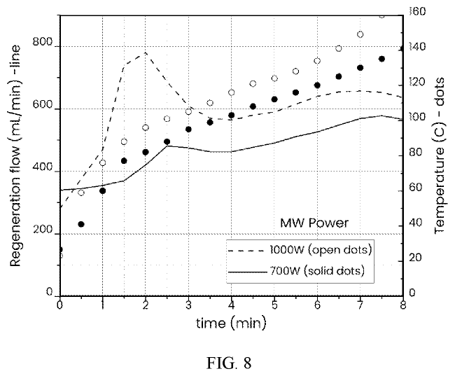

FIG. 8 shows that increasing the microwave power increases the CO₂ release. CO₂ release profiles are shown in FIG. 8. The figure shows that at the same temperatures the CO₂ release strongly increased at 1,000 W power compared to 700 W. The overall trend shows that at the same temperatures higher microwave power results in higher CO₂ release.

Set forth are various aspects of the disclosure.

Aspect 1. A method of selectively releasing CO₂ from a CO₂ loaded solid sorbent, the method comprising: applying an electromagnetic radiation having an intensity of greater than or equal to 0.7 W/cm² and a frequency of about 400 THz to about 70 kHz to the CO₂ loaded solid sorbent to release CO₂; wherein the CO₂ loaded solid sorbent comprises a solid sorbent, and chemisorbed CO₂, physisorbed CO₂; and the solid sorbent comprises at least one amine compound.

Aspect 2. The method as in any prior aspect, wherein the electromagnetic radiation has an intensity of about 0.7 W/cm² to about 1500 W/cm² for continuous radiation or an intensity of about 5 W/cm² to about 500 GW/cm² for pulsed radiation.

Aspect 3. The method as in any prior aspect, wherein the carbon dioxide is selectively released by an energy generated by a vibration excitation via a single photon process.

Aspect 4. The method as in any prior aspect, wherein the CO₂ loaded solid sorbent comprises charged or partially charged groups, and the Coulomb force applied by the electromagnetic radiation acts on the charged or partially charged groups to release CO₂.

Aspect 5. The method as in any prior aspect, wherein the electromagnetic radiation has a photon energy that is lower than a binding energy of the carbon dioxide with the solid sorbent.

Aspect 6. The method as in any prior aspect, wherein the electromagnetic radiation has a wavenumber of about 400 cm⁻¹ to about 4000 cm⁻¹.

Aspect 7. The method as in any prior aspect, wherein a temperature difference of the solid sorbent before and after the selectively release of CO₂ is less than about 10° C.

Aspect 8. The method as in any prior aspect, wherein the electromagnetic radiation has a frequency of about 120 THz to about 0.07 MHz.

Aspect 9. The method as in any prior aspect, wherein an amount of carbon dioxide released increases with increasing intensity of the electromagnetic radiation at a same temperature and a same frequency.

Aspect 10. The method as in any prior aspect, wherein the CO₂ loaded solid sorbent contains co-adsorbed water.

Aspect 11. The method as in any prior aspect, wherein the CO₂ loaded solid sorbent comprises at least one of carbonate ions, bicarbonate ions, ammonium ions, a carbamate, or a carbamic acid.

Aspect 12. The method as in any prior aspect, wherein the solid sorbent has a pore size of about 0.4 nm to about 10 μm.

Aspect 13. The method as in any prior aspect, wherein the solid sorbent has a thermal conductivity of less than 0.1 W/mK.

Aspect 14. The method as in any prior aspect, wherein the solid sorbent further comprises metal sites.

Aspect 15. The method as in any prior aspect, wherein the solid sorbent further comprises organic linkers.

Aspect 16. The method as in any prior aspect, wherein the solid sorbent is a metal-organic framework material functionalized with the amine compound.

Aspect 17. The method as in any prior aspect, wherein less than 10% of carbon dioxide is released when the CO₂ loaded solid sorbent is stored at 20° C. and atmospheric pressure for one week without exposing the CO₂ loaded solid sorbent to the electromagnetic radiation.

Aspect 18. The method as in any prior aspect, wherein the solid sorbent is present in the form of pellets.

Aspect 19. The method as in any prior aspect, wherein the solid sorbent is present in the form of a coating.

Aspect 20. The method as in any prior aspect, wherein the solid sorbent is present in the form of a self-standing monolith.

Aspect 21. The method as in any prior aspect, wherein the temperature of the solid sorbent is in the range of about 213 K to about 423 K, optionally in the range of about 213 K to about 373 K.

Aspect 22. A method of removing carbon dioxide from a gaseous environment or an effluent gas stream, the method comprising: exposing a solid sorbent to the gaseous environment or the effluent gas stream; removing CO₂ from the gaseous environment or the effluent gas stream to form a CO₂ loaded solid sorbent; and applying an electromagnetic radiation having an intensity of greater than or equal to 0.7 W/cm² and a frequency of about 400 THz to about 70 KHz to the CO₂ loaded solid sorbent to release CO₂ and regenerate the solid sorbent; wherein the CO₂ loaded solid sorbent comprises the solid sorbent and chemisorbed CO₂, physisorbed CO₂, or a combination thereof; and the solid sorbent comprises at least one amine compound.

Aspect 23. The method as in any prior aspect, wherein the CO₂ loaded solid sorbent comprises charged or partially charged groups, and the Coulomb force applied by the electromagnetic radiation acts on the charged or partially charged groups to release CO₂.

Aspect 24. The method as in any prior aspect, wherein the electromagnetic radiation has a single photon energy that is lower than a binding energy of the carbon dioxide with the solid sorbent.

The use of the terms “a” and “an” and “the” and similar referents in the context of describing the invention (especially in the context of the following claims) are to be construed to cover both the singular and the plural, unless otherwise indicated herein or clearly contradicted by context. The terms “about”, “substantially” and “generally” are intended to include the degree of error associated with measurement of the particular quantity based upon the equipment available at the time of filing the application. For example, “about” and/or “substantially” and/or “generally” can include a range of +8% or 5%, or 2% of a given value.

Unless defined otherwise, technical and scientific terms used herein have the same meaning as is commonly understood by one of skill in the art to which this invention belongs.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A method of selectively releasing CO₂ from a CO₂ loaded solid sorbent, the method comprising:
applying an electromagnetic radiation having an intensity of greater than or equal to 0.7 watt per square centimeter and a frequency of about 400 terahertz to about 70 kilohertz to the CO₂ loaded solid sorbent to release CO₂;
wherein the CO₂ loaded solid sorbent comprises a solid sorbent and chemisorbed CO₂, physisorbed CO₂, or a combination thereof; and
the solid sorbent comprises at least one amine compound.

2. The method of claim 1, wherein the electromagnetic radiation has an intensity of about 0.7 watt per square centimeter to about 1500 watts per square centimeter for continuous radiation or an intensity of about 5 watts per square centimeter to about 500 gigawatts per square centimeter for pulsed radiation.

3. The method of claim 1, wherein the carbon dioxide is selectively released by an energy generated by a vibration excitation via a single photon process.

4. The method of claim 1, wherein the CO₂ loaded solid sorbent comprises charged or partially charged groups, and the Coulomb force applied by the electromagnetic radiation acts on the charged or partially charged groups to release CO₂.

5. The method of claim 1, wherein the electromagnetic radiation has a photon energy that is lower than a binding energy of the carbon dioxide with the solid sorbent.

6. The method of claim 1, wherein the electromagnetic radiation has a wavenumber of about 400 cm⁻¹ to about 4000 cm⁻¹.

7. The method of claim 6, wherein a temperature difference of the solid sorbent before and after the selectively release of CO₂ is less than about 10° C.

8. The method of claim 1, wherein the electromagnetic radiation has a frequency of about 120 terahertz to about 0.07 megahertz.

9. The method of claim 1, wherein an amount of carbon dioxide released increases with increasing intensity of the electromagnetic radiation at a same temperature and a same frequency.

10. The method of claim 1, wherein the CO₂ loaded solid sorbent contains co-adsorbed water.

11. The method of claim 1, wherein the CO₂ loaded solid sorbent comprises at least one of carbonate ions, bicarbonate ions, ammonium ions, a carbamate, or a carbamic acid.

12. The method of claim 1, wherein the solid sorbent has a pore size of about 0.4 nanometer to about 10 micrometers.

13. The method of claim 1, wherein the solid sorbent has a thermal conductivity of less than 0.1 watt per meter-kelvin.

14. The method of claim 1, wherein the solid sorbent further comprises metal sites.

15. The method of claim 14, wherein the solid sorbent further comprises organic linkers.

16. The method of claim 1, wherein the solid sorbent is a metal-organic framework material functionalized with the amine compound.

17. The method of claim 1, wherein less than 10% of carbon dioxide is released when the CO₂ loaded solid sorbent is stored at 20° C. and atmospheric pressure for one week without exposing the CO₂ loaded solid sorbent to the electromagnetic radiation.

18. The method of claim 1, wherein the solid sorbent is present in the form of pellets.

19. The method of claim 1, wherein the solid sorbent is present in the form of a coating.

20. The method of claim 1, wherein the solid sorbent is present in the form of a self-standing monolith.

21. The method of claim 1, wherein the temperature of the solid sorbent is in the range of about 213 Kevin to about 423 Kevin.

22. A method of removing carbon dioxide from a gaseous environment or an effluent gas stream, the method comprising:
exposing a solid sorbent to the gaseous environment or the effluent gas stream;
removing CO₂ from the gaseous environment or the effluent gas stream to form a CO₂ loaded solid sorbent; and
applying an electromagnetic radiation having an intensity of greater than or equal to 0.7 watt per square centimeter and a frequency of about 400 terahertz to about 70 kilohertz to the CO₂ loaded solid sorbent to release CO₂ and regenerate the solid sorbent;
wherein the CO₂ loaded solid sorbent comprises the solid sorbent and chemisorbed CO₂, physisorbed CO₂, or a combination thereof; and
the solid sorbent comprises at least one amine compound.

23. The method of claim 22, wherein the CO₂ loaded solid sorbent comprises charged or partially charged groups, and the Coulomb force applied by the electromagnetic radiation acts on the charged or partially charged groups to release CO₂.

24. The method of claim 22, wherein the electromagnetic radiation has a single photon energy that is lower than a binding energy of the carbon dioxide with the solid sorbent.
